(19) United States
(12) Patent Application Publication
(10) Pub. No.: US 2016/0108861 A1
(43) Pub. Date: Apr. 21, 2016

(54) Engine Management System

(71) Applicant: Matthew G. Riddle, McLean, VA (US)

(72) Inventor: Matthew G. Riddle, McLean, VA (US)

(21) Appl. No.: 14/514,419

(22) Filed: Oct. 15, 2014

(51) Int. Cl. F02M 25/07

(52) U.S. Cl. CPC F02M 25/0737; F02M 25/0706

(57) ABSTRACT

An engine management system that maximizes the efficiency of internal combustion engines (gasoline or diesel) based on the performance demanded of the engine and the environmental conditions that the engine is operating in. The engine intake and cooling systems are arranged such that that the engine intake air temperature and pressure and coolant temperature are continuously optimized to provide reduced emissions on start-up and increased efficiency and performance in all environmental conditions.

### BACKGROUND

The present disclosure relates to vehicle engine management systems and more particularly, to systems and methods for protecting and improving the vehicle engine performance.

In the cooling system of vehicles, excess heat from the engine is removed by an engine coolant. In a typical turbo and/or supercharged engine equipped with an air to air intercooler system (AAICS), such as that illustrated in FIG. 1, a coolant at temperature T₁₁ is circulated through the engine to absorb the heat from the engine. Engine heat increases the temperature of the coolant to T₁₂. In AAICS 100, the coolant returning from the engine 110 passes through a radiator 120 which receives ambient air having a temperature of T_{A}. Heat removed from the engine by the coolant dissipates into the atmosphere. The temperature of the coolant decreases from T₁₂ to T₁₁. The coolant continues to circulate through the engine and (passes through) the radiator in this manner to remove heat from the engine. The coolant is typically in a liquid form that does not freeze in cold settings.

Typically, the ambient temperature for T_{A} is below 60° C. The coolant temperature T₁₁ (going into the engine) is approximately 80° C. and the coolant temperature T₁₂ (coming out of the engine) is approximately 100° C. Therefore, the relationship between the ambient temperature and the various coolant temperatures is T_{A}<T₁₁<T₁₂.

AAICS 100 also includes a compressor 130 that receives ambient air at temperature T_{A} and pressure at P_{A}. Turbo compressor 130 compresses the air to temperature T₁₃ and pressure P₁₃. The pressurized air is then passed through radiator 140. Radiator 140 receives ambient air with a temperature of T_{A} and pressure of P_{A}. The temperature and pressure of the compressed air that passes through radiator 140 are reduced to T₁₄ and P₁₄.

The air from the radiator at T₁₄, P₁₄ is then also provided to engine 110 as engine intake air. Engine 110, therefore, receives coolant at temperature T₁₁ and air at temperature T₁₄ and pressure P₁₄. The heat generated by the engine and the engine intake air increases the coolant temperature to T₁₂.

The ambient temperature T_{A} can be below 60° C. and the ambient pressure can be at approximately one (1) bar. T₁₃ can be approximately 240° C. and P₁₃ can be approximately at two (2) bars. T₁₄ can be approximately 90° C. and P₁₄ can be at two (2) bars.

Therefore, the relationship between the ambient temperature and the various air temperatures can be represented by T_{A}<T₁₄<T₁₃. The relationship between the ambient pressure and the various air pressures can be represented by P_{A}<P₁₄≅P₁₃ where “≅” represents P₁₄ being approximately equal to P₁₃. The relationship between the various coolant and air temperatures can be represented by T_{A}<T₁₁<T₁₄<T₁₂<T₁₃.

Other existing cooling systems include an air to water intercooler system (AWICS) such as that illustrated in FIG. 2. In AWICS 200, coolant returning from engine 210 at T₂₂ passes through radiator 220 (which receives ambient air at T_{A}) to reduce the temperature to T₂₁. The coolant then passes through radiator 240 and then flows back to the engine.

The value of ambient temperature T_{A} can be, for example, less than 60° C. while that of the coolant T₂₁ can be approximately 70° C. and that of T₂₂ can be approximately 100° C. The relationship between the ambient temperature and the various coolant temperatures can be represented by T_{A}<T₂₁<T₂₂.

Compressor 230 receives ambient air at temperature T_{A} and pressure at P_{A}. The air is compressed and the temperature of the compressed air increases to T₂₃ and the pressure increases to P₂₃. The compressed air passes through radiator 240. Radiator 240 (unlike 140), does not receive ambient air.

Heat transfers from the compressed air to the engine coolant in radiator 240 which results in the temperature of the coolant increasing from T₂₁ to T₂₅ after passing through radiator 240. The coolant circulates through engine 210. The temperature of the compressed air decreases to T₂₄ after passing through radiator 240 and the pressure decreases to P₂₄. The compressed air is supplied to the engine as engine intake air.

The value of T₂₃ can be approximately 240° C. and P₂₃ can be approximately at two (2) bars. T₂₄ can be approximately 95° C. and P₂₄ can be at two (2) bars. T₂₅ can be approximately 80° C.

The relationship between the various air temperatures for AWICS 200 can be expressed as T_{A}<T₂₄<T₂₃. The relationship between the pressure values can be represented by for example, P_{A}<P₂₄≅P₂₃ where “≅” represents P₂₄ being approximately equal to P₂₃. The relationship between the various coolant temperatures and the various air temperatures can be represented by T_{A}<T₂₁<T₂₅<T₂₄<T₂₂<T₂₃.

In the AAICS of FIG. 1, radiators 120 and 140 and compressor 130 receive ambient air. In the AWICS of FIG. 2, radiator 220 and compressor 230 receive ambient air. Radiator 240 does not receive ambient air. Radiator 220 will likely be larger in size than radiator 120 since radiator 220 is responsible for all the heat being rejected by the cooling system to the ambient air.

In existing systems, such as AAICS 100 of FIG. 1 and AWICS 200 of FIG. 2 described above, the temperature of the engine intake air is higher than the temperature of the coolant circulating through the engine. In normal engine operation (not necessarily while engines are being warmed up), it is typically desirable to have lower engine intake air temperatures to facilitate a more efficient engine performance.

### SUMMARY

According to an exemplary embodiment, an engine management system is disclosed. The engine management system comprises: a first radiator for providing coolant to an engine and for cooling the coolant returning from the engine utilizing air at ambient temperature; a compressor for compressing air received at ambient temperature and ambient pressure and for outputting the compressed air; a second radiator located between the first radiator and the engine for receiving compressed air from the compressor and the coolant from the first radiator and for supplying the coolant to the engine and for outputting the compressed air; and a variable expansion valve for receiving the compressed air output from the second radiator and for outputting the expanded air to the engine wherein a level of expansion or compression of the variable expansion valve is based on a required engine performance level.

According to another exemplary embodiment, an engine management system comprises: a first radiator for providing coolant to an engine and for cooling the coolant returning from the engine utilizing air at ambient temperature; a compressor for compressing air received at ambient temperature and ambient pressure and for outputting the compressed air; a second radiator located between the first radiator and the engine for receiving compressed air from the compressor and the coolant from the first radiator and for supplying the coolant to the engine and for outputting the compressed air; an expansion valve for receiving the compressed air output from the second radiator and for outputting an expanded air; and a plurality of flow paths for selectively directing air to the engine, wherein a selected one of the flow paths corresponds to a particular engine performance level.

According a further exemplary embodiment, a method for providing intake air to a vehicle engine is disclosed. The method comprises: receiving air having an ambient temperature and an ambient pressure by a compressor; compressing the received air wherein the compressed air has a first temperature and a first pressure; and selectively providing the compressed air via at least one of a plurality of flow paths to the engine, the flow path being determined by verifying an operating mode of the engine.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates an air to air intercooler system;

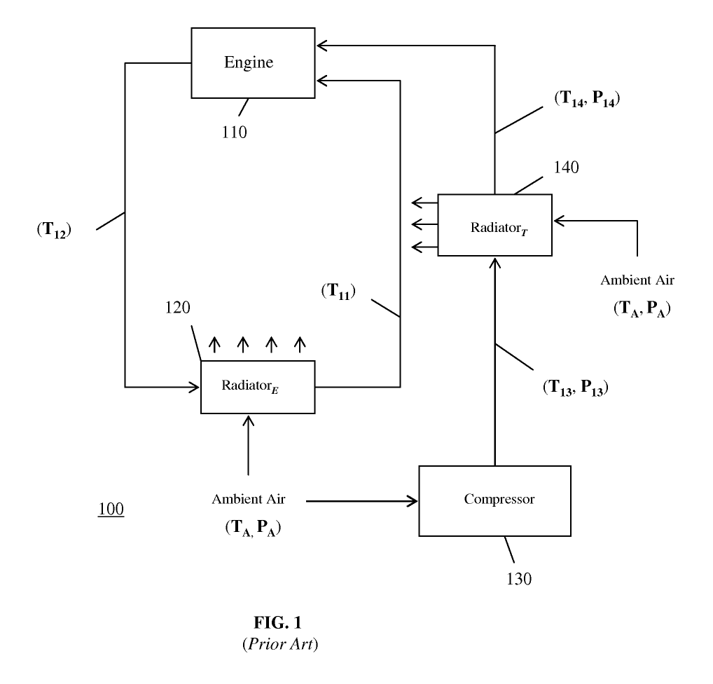

FIG. 2 illustrates an air to water intercooler system;

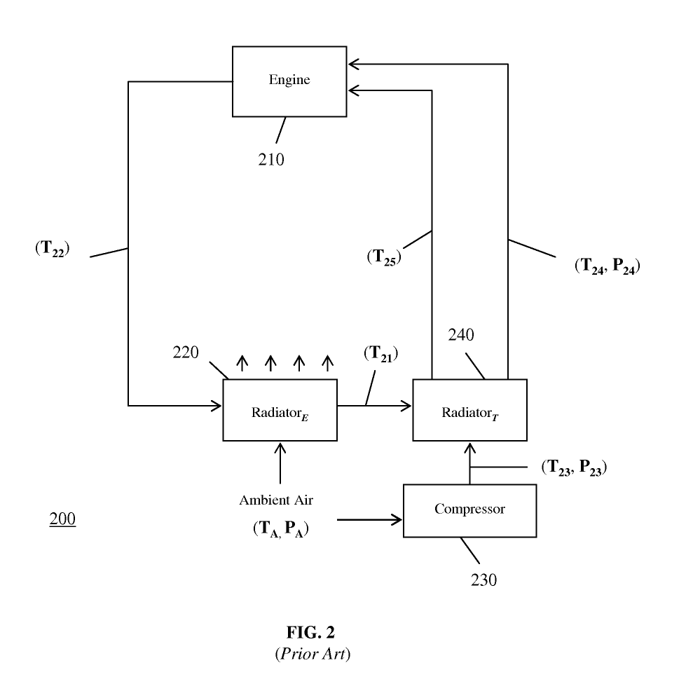

FIG. 3 illustrates an air to water intercooler system in accordance with an exemplary embodiment;

FIG. 4 illustrates an air to water intercooler system in accordance with other exemplary embodiment; and

FIG. 5 illustrates a method in accordance with exemplary embodiments.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the exemplary embodiments.

Reference throughout this specification to an “exemplary embodiment” or “exemplary embodiments” means that a particular feature, structure, or characteristic as described is included in at least one embodiment. Thus, the appearances of these terms and similar phrases in various places throughout this specification are not necessarily all referring to the same embodiment. Furthermore, the particular features, structures, or characteristics may be combined in any suitable manner in one or more embodiments. The headings provided herein are for convenience only and do not interpret the scope or meaning of the embodiments.

According to exemplary embodiments, a compressor (one or more turbo and/or supercharges) and a variable expansion valve may be utilized to decrease the temperature of engine intake air.

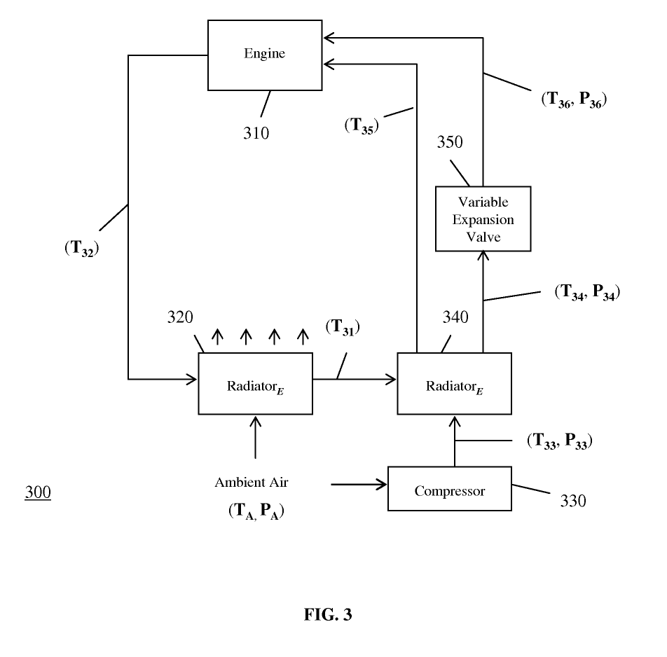

An exemplary air to water intercooler system (AWICS) as illustrated in FIG. 3 includes a variable expansion valve 350. In AWICS 300, coolant returning from engine 310 at T₃₂ is passed through radiator 320. Radiator 320 receives ambient air at T_{A}. The temperature of the coolant is reduced to T₃₁ after the coolant passes through radiator 320. The coolant is then passed through radiator 340.

Compressor 330 receives ambient air having a temperature of T_{A} and pressure of P_{A}. Compressor 330 can compress the received air. The temperature of the compressed air increases to T₃₃ and the pressure increases to P₃₃. The compressed air also passes through radiator 340. Radiator 340 (like radiator 240), does not receive ambient air.

Due to heat transfer from the compressed air to the engine coolant in radiator 340, the temperature of the coolant increases to T₃₅ after the coolant passes through radiator 340. The coolant at temperature T₃₅ is circulated through engine 310. The temperature of the compressed air from compressor 330 decreases to T₃₄ after the air passes through radiator 340 and the pressure decreases to P₃₄.

Air from radiator 340 may pass through variable expansion valve 350 resulting in a further decrease in temperature of the compressed air to T₃₆ and a further decrease in pressure to P₃₆. The level or degree of expansion or compression of valve 350 may vary based on a specified criterion. The criterion may include a desired level of efficiency or performance of the engine for example.

For a high performance mode, the valve may be compressed. That is, the level of compression may be high or the level of expansion may be low. For a low or economical mode, the valve may be expanded. That is, the level of expansion may be high or the level of compression may be low. The variable expansion valve may be expanded or compressed to optimize or maximize the performance and efficiency of the engine. Various performance modes may be specified or selected within a vehicle in which an exemplary engine management system as described herein may be included.

The selection may be via a selector button accessible to the user of the vehicle for example (i.e. performance or efficiency modes). The modes may also be determined automatically by the engine management system based on sensor readings representing the vehicle user's operating manner and/or the user settings above.

The coolant at temperature T₃₅ can be circulated through engine 310. Air from variable expansion valve 350 at temperature T₃₆ and pressure P₃₆ can also be provided to the engine as engine intake air. The air from the variable expansion valve 350 may be referred to as “expanded” air.

In accordance with exemplary embodiments, the temperature of the air after passing through variable expansion valve 350 (i.e. T₃₆) may decrease. For a high performance mode, the temperature of the air provided to the engine can be at a level that is below the temperature of the ambient air (T_{A}).

The ambient temperature T_{A} can be, for example, less than 60° C. while that of coolant temperature T₃₁ can be approximately 70° C., that of coolant temperature T₃₂ can be approximately 100° C. and that of coolant temperature T₃₅ can be approximately 80° C. The relationship between the ambient temperature and various coolant temperatures can be represented by T_{A}<T₃₁<T₃₅<T₃₂ for example.

The value of P_{A} can be, for example, at approximately one (1) bar. Air temperature T₃₃ can be, for example, approximately 270° C. and air pressure P₃₃ can be approximately at two and one half (2.5) bars. Air temperature T₃₄ can be approximately 105° C. and air pressure P₃₄ can be at two and one half (2.5) bars. Air temperature T₃₆ can be approximately 35° C. and air pressure P₃₆ can be at two (2) bars.

The relationship between the ambient temperature and the various air temperatures can be represented by T₃₆<T_{A}<T₃₄<T₃₃ for example. The relationship between the ambient temperature and the various coolant and air temperatures can be expressed by T₃₆<T_{A}<T₃₁<T₃₅<T₃₂<T₃₄<T₃₃ for example. The relationship between the ambient pressure and the various air pressures can be represented by P_{A}<P₃₆<P₃₄≅P₃₃ for example where “≅” represents P₃₄ being approximately equal to P₃₃.

In AWICS 300 of FIG. 3, radiator 320 and compressor 330 are exposed to ambient air. Radiator 340 does not receive ambient air. Radiator 320 may be larger in dimension or size than radiator 120.

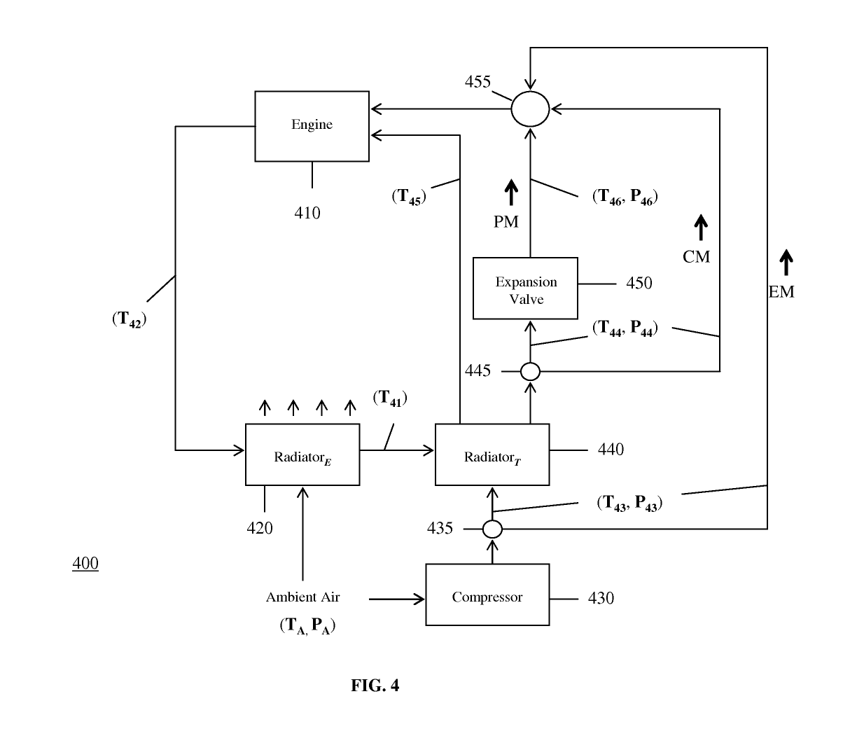

The various performance modes described herein may also be realized by an exemplary AWICS 400 as illustrated in FIG. 4. AWICS 400 may utilize one of a plurality of flow paths for providing engine intake air based on a desired performance level. Compressor 430, radiator 440 may correspond to their respective counterparts 330 and 340 in AWICS 300 of FIG. 3. Various performance levels or modes for the engine may be available such as an Economy Mode (EM), a Combination Mode (CM) and a Power Mode (PM).

If a performance mode is required as described above with reference to FIG. 3, the engine intake air may be provided via flow path PM passing through expansion valve 450. Expansion valve 450 can reduce the temperature of the air from radiator to engine 410 (T₄₆) to a level that is lower than the ambient temperature T_{A}. Expansion valve 450 can be similar to expansion valve 350 of FIG. 3 in that it can be a variable expansion valve.

If an economy mode is required, the engine intake air may be provided via flow path EM directly from the turbo compressor 430 at T₄₃ without utilizing radiator 440 and expansion valve 450.

If a combination mode (that is between, or a combination of, a performance mode and an economy mode) is required, the engine intake air may be provided at T₄₄ via flow path CM which bypasses expansion valve 450.

In an economy mode, a flow path valve 435 may direct compressed air directly to the engine. In this mode, since compressed air is not directed to radiator 440, coolant temperature entering radiator 440 may be equal to coolant temperature leaving radiator 440 (i.e. T₄₁=T₄₅). In a combination mode, a flow path switch 445 may direct air output from radiator 440 to the engine. A flow path switch 445 may direct air from the selected path (i.e. one of EM, CM and PM) to the engine.

While the various modes described herein indicate the air flowing to the engine from the compressor via one of the paths, during a switch over between modes, the air may flow along more than one path. For example, if the vehicle is in an economy mode, the air may flow along path EM. If the mode is switched to a performance mode, the air flow can commence along flow path PM during the switchover of the modes while air may still be flowing along path EM. The flow paths can be adjusted continuously to maximize the performance and efficiency of the engine.

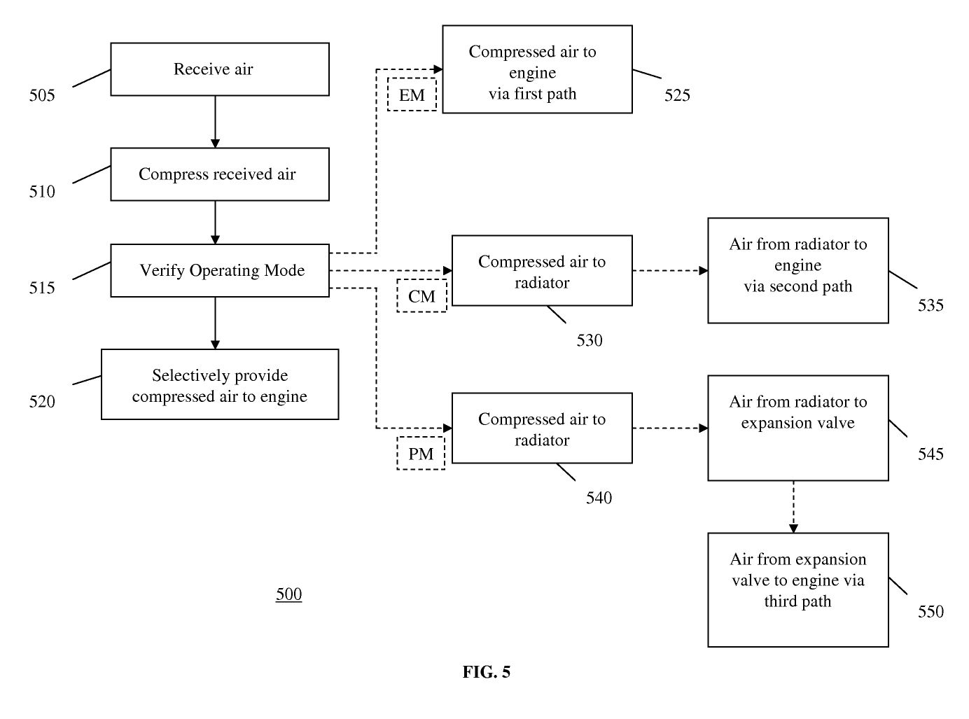

A method in accordance with exemplary embodiments may be illustrated with reference to FIG. 5. According to exemplary method 500, air may be received by a compressor at 505. The received air may be ambient air and therefore, be at an ambient temperature and an ambient pressure. The received air may be compressed at 510. The compressed air may be at a first temperature that is higher than the ambient temperature. The compressed air may be at a first pressure that is higher than the ambient pressure. An operating mode of the engine may be verified at 515. The compressed air may be selectively provided via at least one of a plurality of paths to the engine at 520 depending on the verified operating mode of the engine. The operating mode may be one of an economy mode, a combination mode and a performance mode.

If the operating mode is an economy mode, the compressed air may be provided to the engine via a first flow path at 525 (economy mode or EM of FIG. 4). The compressed air may be at a first temperature that is higher than the ambient temperature and at a first pressure that is higher than the ambient pressure.

If the operating mode is a combination mode, the compressed air at a first temperature that is higher than the ambient temperature and at a first pressure that is higher than the ambient pressure may be provided to a radiator (radiator 440 of FIG. 4) at 530. The air output from the radiator may be provided to the engine via a second flow path at 535 (CM of FIG. 4). The air output from the radiator may be at a second temperature lower than the first temperature and at a second pressure lower than the first pressure.

If the operating mode is a performance mode, the compressed air at a first temperature that is higher than the ambient temperature and at a first pressure that is higher than the ambient pressure may be provided to a radiator (radiator 440 of FIG. 4) at 540. The air output from the radiator at a second temperature lower than the first temperature and at a second pressure lower than the first pressure may be provided to an expansion valve (expansion valve 450 of FIG. 4) at 545. Air output from the expansion valve at a third temperature lower than the second temperature and at a third pressure lower than the second pressure may be provided to the engine via third flow path (PM of FIG. 4) at 550.

The step of selectively providing air may be general in nature while the steps for providing air via one at least one of the flow paths may be more specific and are illustrated by dashed flow lines.

Multiple advantages may be realized utilizing exemplary embodiments as described above. Engine intake air at lower temperatures (such as T₃₆) is highly desirable from an engine efficiency and performance point of view. A lower intake air temperature allows a lower octane fuel to be used without causing pre-combustion in gasoline equipped engines. Simultaneously, during engine warm up, engine intake air temperatures higher than ambient air temperature can be desirable for providing a faster warm up (or reaching operating temperature more quickly) and corresponding reduction in engine emissions. The higher intake air temperatures realized by providing compressed air directly into the engine facilitates such faster warm up.

The numerical values provided for temperature and pressure are for illustrative and exemplary purposes only and are not limiting in any manner. Turbo compressors described herein may be mechanically or electrically driven. Although exemplary embodiments have been disclosed, it will be apparent to those skilled in the art that various changes and modifications can be made which will achieve some of the advantages of embodiments without departing from the spirit and scope of the disclosure. Such modifications are intended to be covered by the appended claims.

Further, in the description and the appended claims the meaning of “comprising” is not to be understood as excluding other elements or steps. Further, “a” or “an” does not exclude a plurality, and a single unit may fulfill the functions of several means recited in the claims.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in relevant art.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. An engine management system comprising:
a first radiator for providing coolant to an engine and for cooling the coolant returning from the engine utilizing air at ambient temperature;
a compressor for compressing air received at ambient temperature and ambient pressure and for outputting the compressed air;
a second radiator located between the first radiator and the engine for receiving compressed air from the compressor and the coolant from the first radiator and for supplying the coolant to the engine and for outputting the compressed air; and
a variable expansion valve for receiving the compressed air output from the second radiator and for outputting the expanded air to the engine wherein a level of expansion or compression of the variable expansion valve is based on a required engine performance level.

2. The engine management system of claim 1, wherein the level of compression is higher if a high level of performance is required by the engine, the high level including at least one of increased torque and increased horsepower.

3. The engine management system of claim 2, wherein the level of expansion is higher if a low level of performance is required by the engine, the low level including at least one of lower torque or lower horsepower.

4. The engine management system of claim 1, wherein a temperature of the expanded air is lower than the ambient temperature.

5. The engine management system of claim 1, wherein the supply of engine intake air having a lower temperature facilitates the utilization of a lower octane fuel and eliminating pre-combustion in gasoline equipped engines.

6. The engine management system of claim 1, wherein the supply of engine intake air having a higher temperature from compression facilitates achieving an engine operating temperature in a shorter period of time.

7. The engine management system of claim 1, wherein:
a temperature of the coolant returning from the engine is higher than a temperature of the coolant received by the second radiator;
a temperature of the coolant provided to the engine is higher than a temperature of the coolant received by the second radiator;
a temperature of the coolant provided to the engine is higher than a temperature of the ambient air temperature; and
a temperature and a pressure of compressed air is higher than the temperature and a pressure of ambient air.

8. The engine management system of claim 1, wherein:
each of a temperature and a pressure of compressed air is higher than the temperature and a pressure of ambient air; and
each of a pressure and a temperature of the compressed air output by the second radiator is lower than the temperature and a pressure of the compressed air.

9. An engine management system comprising:
a first radiator for providing coolant to an engine and for cooling the coolant returning from the engine utilizing air at ambient temperature;
a compressor for compressing air received at ambient temperature and ambient pressure and for outputting the compressed air;
a second radiator located between the first radiator and the engine for receiving compressed air from the compressor and the coolant from the first radiator and for supplying the coolant to the engine and for outputting the compressed air;
an expansion valve for receiving the compressed air output from the second radiator and for outputting an expanded air; and
a plurality of flow paths for selectively directing air to the engine, wherein a selected one of the flow paths corresponds to a particular engine performance level.

10. The engine cooling system of claim 9, further comprising:
a first flow path switch located between the compressor and the second radiator for directing air along a first one of the flow paths from the compressor to the engine.

11. The engine cooling system of claim 10, further comprising:
a second flow path switch located between the second radiator and the expansion valve for directing air along a second one of the flow paths from the second radiator to the engine.

12. The engine cooling system of claim 11, further comprising:
a third flow path switch located between the between the engine and each of the expansion valve, the first flow path switch and the second flow path switch.

13. The engine cooling system of claim 12, wherein the third flow path switch allows air flow from at least one of the expansion valve, the first flow path and the second flow path to the engine.

14. The engine cooling system of claim 13, wherein the first path corresponds to an engine performance level corresponding to at least one of a lower torque level and a lower horsepower.

15. The engine cooling system of claim 13, wherein the second path corresponds to an engine performance level corresponding to at least one of a mid torque level and a mid horsepower.

16. The engine cooling system of claim 9, wherein the air is provided by the expansion valve to the engine if a high engine performance level is selected, the high performance level corresponding to at least one of a high torque level and a high horsepower.

17. A method of providing intake air to a vehicle engine, the method comprising the steps of:
receiving air having an ambient temperature and ambient pressure by a compressor;
compressing the received air wherein the compressed air has a first temperature and a first pressure; and
selectively providing the compressed air via at least one of a plurality of flow paths to the engine, the flow path being determined by verifying an operating mode of the engine.

18. The method of claim 17, further comprising:
if the operating mode is an economy operating mode,
providing the compressed air to the engine via a first flow path wherein the first temperature is higher than the ambient temperature and the first pressure is higher than the ambient pressure.

19. The method of claim 17, further comprising:
if the operating mode is a combination mode,
passing the compressed air through a radiator wherein the first temperature is higher than the ambient temperature and the first pressure is higher than the ambient pressure;
providing the air output from the radiator to the engine via a second flow path wherein the air from the radiator has a second temperature lower than the first temperature and a second pressure lower than the first pressure.

20. The method of claim 17, further comprising:
passing the compressed air through a radiator wherein the first temperature is higher than the ambient temperature and the first pressure is higher than the ambient pressure;
providing the air output from the radiator to an expansion valve wherein air output from the radiator has a second temperature lower than the first temperature and a second pressure lower than the first pressure; and
providing the air output from the expansion valve to the engine via the third flow path wherein the air output from the expansion has a third temperature lower than the second temperature and a third pressure lower than the second pressure.
